(19) United States
(12) Patent Application Publication
(10) Pub. No.: US 2014/0110593 A1
(43) Pub. Date: Apr. 24, 2014

(54) Method and Apparatus for Fabricating Boron Coated Straws for Neutron Detectors

(71) Applicant: Proportional Technologies, Inc., Houston, TX (US)

(72) Inventor: Jeffrey L. Lacy, Houston, TX (US)

(73) Assignee: Proportional Technologies, Inc., Houston, TX (US)

(21) Appl. No.: 14/060,507

(22) Filed: Oct. 22, 2013

Related U.S. Application Data
(60) Provisional application No. 61/717,000, filed on Oct. 22, 2012.

(51) Int. Cl. B23K 31/02; G01T 3/00

(52) U.S. Cl. CPC B23K 31/027; G01T 3/008
USPC 250/390.01; 228/111; 228/173.4; 228/170; 228/1.1

(57) ABSTRACT

An apparatus and a process are disclosed for straw tube formation utilized in manufacturing boron coated straw neutron detectors. A preferred embodiment of the process for creating a thin walled straw for use in a boron-coated straw neutron detector comprises providing foil having a boron coating on a surface, forming the coated foil into a cylindrical tube having a longitudinal seam and the boron coated surface on the inside of the cylindrical tube, and then ultrasonically welding closed the seam of the tube. Optionally, the cylindrical tube can then be drawn through a die to form a straw tube having a non-circular cross section, preferably a star-shaped cross section.

### RELATED APPLICATIONS

This application claims priority to U.S. Provisional Application No. 61/717,000 (“the '000 application”) filed Oct. 22, 2012. The '000 application is hereby incorporated by reference in its entirety for all purposes, including but not limited to, all portions describing the tube forming process of the present invention, those portions describing boron-coated straw detectors in general as background and for use as specific embodiments of the present invention, and those portions describing other aspects of manufacturing and testing of boron-coated straws that may relate to the present invention.

### GOVERNMENTAL SPONSORSHIP

This invention was made with government support under DTRA01-02-D-0067 awarded by Defense Threat Reduction Agency and HSHQDC-12-C-00094 awarded by the Domestic Nuclear Detection Office. The government may have certain rights in the invention.

### REFERENCE TO A SEQUENTIAL LISTING

Not applicable.

### BACKGROUND OF THE INVENTION

1. Field of the Invention

This invention relates to fabricating thin walled straws from coated foil. More particularly, this invention relates to fabricating thin walled straws from boron coated foils utilizing ultrasonic welding. Even more particularly, this invention relates to a continuous process for fabricating thin walled straws from boron coated foils for use in neutron detectors utilizing ultrasonic welding.

2. Description of the Related Art

The application of neutron detection technology to the fields of national security, oil/gas exploration, nuclear safeguards, neutron science instrumentation and other areas is greatly expanding. Unfortunately, the neutron detection systems of choice which utilizes pressurized tubes of ³He have several limitations. While these systems can provide the needed spatial resolution and gamma ray discrimination, this technology cannot achieve high rate operation because of slow drift of positive ions. Furthermore, large detection areas are costly, because of the complexity of the pressure vessels required, and parallax errors limit the time-of-flight accuracy of the instrument. Perhaps the most problematic issue for the future of ³He detectors is a severe shortage of ³He. Existing stockpiles of 3 He will soon be depleted and only limited amounts are naturally available or available from decay of U.S. and Russian tritium supplies. Future instrument expansions will likely not afford the escalating cost of the dwindling 3He supply.

Recognizing the problems with ³He detector systems early on, Dr. Jeffery L. Lacy developed a new technology for replacing the ³He detectors. The technology was the boron-coated straw detector. The boron-coated straw (BCS) detector was based on arrays of thin walled boron-coated copper tubes. The elemental component of this detector was a long tube (“straw”), generally about 1 to 4 mm in diameter, coated on the inside with a thin layer of ¹⁰B-enriched boron carbide (¹⁰B₄C).

Thermal neutrons captured in ¹⁰B are converted into secondary particles, through the ¹⁰B(n,α) reaction:

¹⁰B+n→⁷Li+α (1)

The ⁷Li and α particles are emitted isotropically in opposite directions with kinetic energies of 1.47 MeV and 0.84 MeV, respectively (dictated by the conservation of energy and momentum). For a boron carbide layer that is only about 1 μm thick, one of the two charged particles will escape the wall 78% of the time, and ionize the gas contained within the straw.

Each BCS detector was operated as a proportional counter, with its wall acting as the cathode, and a thin wire tensioned through its center serving as the anode electrode, operated at a high positive potential. Primary electrons liberated in the gas drift to the anode, and in the high electric field close to the anode, avalanche multiplication occurs, delivering a very much amplified charge on the anode wire. Standard charge-sensitive preamplifier and shaping circuitry were used to produce a low noise pulse for each neutron event. Gamma interactions in the wall produced near minimum ionizing electrons that deposit a small fraction of the energy of the heavily ionizing alpha and Li products. Gamma signals were effectively discriminated with a simple pulse height threshold.

The boron-coated straw detector technology was first patented by Dr. Lacy in U.S. Pat. No. 7,002,159 entitled “Boron-Coated Straw Neutron Detector” based upon a Nov. 13, 2002, filing. As the thought leader of this technology area, Dr. Lacy continued his research and development to improve the boron coated straw detectors and to find new uses. Examples of Dr. Lacy's continued progress in this technology area are found in his other issued patents and pending patent applications which include: U.S. Pat. No. 8,330,116 entitled “Long Range Neutron-Gamma Point Source Detection and Imaging Using Rotating Detector”; U.S. patent application Ser. No. 12/792,521 filed Jun. 2, 2010, entitled “Optimized Detection of Fission Neutrons Using Boron-Coated Straw Detectors Distributed in Moderator Material” (allowed and issue fee paid); U.S. patent application Ser. No. 13/106,785 filed May 12, 2011, entitled “Sealed Boron-Coated Straw Detectors”; U.S. patent application Ser. No. 13/106,818 filed May 12, 2011, entitled “Neutron Detectors for Active Interrogation”; and U.S. patent application Ser. No. 13/683,404 filed Nov. 21, 2012, entitled “Boron Coated Straw Detectors with Shaped Straws.” These patent and pending applications mentioned in this paragraph are hereby incorporated by reference in their entirety for all purposes, including but not limited to those portions describing the structure and technical details of the boron-coated straw detectors as background and for use as specific embodiments of the present invention, and those portions describing other aspects of manufacturing and testing of boron-coated straws that may relate to the present invention.

Dr. Lacy also widely published articles on boron-coated straw detection capabilities, fabrication, and development of prototypes for various applications including:
J. L. Lacy, et al, “Novel neutron detector for high rate imaging applications”, IEEE Nuclear Science Symposium Conference Record, 2002, vol. 1, pp. 392-396;
J. L. Lacy, et al, “Straw detector for high rate, high resolution neutron imaging”, in IEEE Nuclear Science Symposium Conference Record, 2005, vol. 2, pp. 623-627;
J. L. Lacy, et al, “High sensitivity portable neutron detector for fissile materials detection”, IEEE Nuclear Science Symposium Conference Record, 2005, vol. 2, pp. 1009-1013;
J. L. Lacy, et al, “Performance of 1 Meter Straw Detector for High Rate Neutron Imaging”, IEEE Nuclear Science Symposium Conference Record, 2006, vol. 1, pp. 20-26;
J. L. Lacy, et al, “Long range neutron-gamma point source detection and imaging using unique rotating detector”, IEEE Nuclear Science Symposium Conference Record, 2007, vol. 1, pp. 185-191,
J. L. Lacy, et al, “Fabrication and materials for a long range neutron-gamma monitor using straw detectors”, IEEE Nuclear Science Symposium Conference Record, 2008, pp. 686-691;
J. L. Lacy, et al, “One meter square high rate neutron imaging panel based on boron straws”, IEEE Nuclear Science Symposium Conference Record, 2009, pp. 1117-1121;
J. L. Lacy, et al, “Boron coated straw detectors as a replacement for ³He”, IEEE Nuclear Science Symposium Conference Record, 2009, pp. 119-125;
J. L. Lacy, et al, “One meter square high rate neutron imaging panel based on boron straws”, IEEE 2009 Nuclear Science Symposium Conference Record, 2009, pp. 1117-1121;
J. L. Lacy, et al, “Initial performance of large area neutron imager based on boron coated straws”, IEEE 2010 Nuclear Science Symposium Conference Record, 2010, pp. 1786-1799;
J. L. Lacy, et al, “Initial performance of sealed straw modules for large area neutron science detectors”, IEEE 2011 Nuclear Science Symposium Conference Record, 2011 Nuclear Science Symposium Conference Record, 2011, pp. 431-435;
J. L. Lacy, et al, “Straw-Based Portal Monitor ³He Replacement Detector with Expanded Capability”, IEEE 2011 Nuclear Science Symposium Conference Record, 2011, pp. 431-435;
J. L. Lacy, et al, “Performance of a Straw-Based Portable Neutron Coincidence/Multiplicity Counter”, IEEE 2011 Nuclear Science Symposium Conference Record, 2011, pp. 529-532;
J. L. Lacy, et al, “Replacement of ³He in Constrained-Volume Homeland Security Detectors”, IEEE 2011 Nuclear Science Symposium Conference Record, 2011, pp. 324-325;
J. L. Lacy, et al, “Initial performance of sealed straw modules for large area neutron science detectors”, IEEE 2011 Nuclear Science Symposium Conference Record, 2011, pp. 431-435;
J. L. Lacy, et al, “Boron-coated straws as a replacement for 3He-based neutron detectors”, Nuclear Instruments and Methods in Physics Research, Vol. 652, 2011, pp. 359-363;
J. L. Lacy, et al, “Design and Performance of High-Efficiency Counters Based on Boron-Lined Straw Detectors”, Institute of Nuclear Materials Management Annual Proceedings, 2012;
J. L. Lacy, et al, “Boron-coated straw detectors of backpack monitors”, IEEE Transactions on Nuclear Science, Vol. 60, No. 2, 2013, pp. 1111-1117.
J. L. Lacy, et al, “The Evolution of Neutron Straw Detector Applications in Homeland Security”. IEEE Transactions on Nuclear Science, Vol. 60, No. 2, 2013, pp. 1140-1146.
   Each of these publications is hereby incorporated by reference into this application in their entirety for all purposes.

The '159 patent discloses the prior art technique utilized to manufacture boron-coated straw tubes. As stated in the '159 patent at column 3, lines 46-51, “Ribbons of such ¹⁰B coated material may be helically wound with a second ribbon having no such ¹⁰B coating as an outer overlapping layer (i.e., one over the other) with application of a very thin fast setting adhesive layer onto a precision cylindrical mandrel, producing a strongly bonded and rigid, geometrically precise cylindrical detector body.” The prior art process is further described at column 9, lines 6-12 of the '159 patent as “Straws are manufactured using a high speed winding technique in which narrow ribbons of plastic or metal-coated plastic film are helically wound around a cylindrical mandrel of precise dimension. Quickset adhesive may be applied to the film on the fly to instantly bond the multiple layers of plastic film together.” FIG. 1 discloses a representation of the prior art straw tube manufacturing process developed by Dr. Lacy and disclosed in the '159 patent.

In practice, the method of producing straw tubes disclosed in the '159 patent, while a significant technological achievement, had several limitations. Initially, the adhesive utilized to bond the straw together could give off gases during operation and the outgas could interfere with detector performance. Further, the temperature limits of the adhesive could also limit the conditions under which the detectors could operate. Finally, boron-coated straws of the prior art formation were not readily shaped to have non-circular cross sections.

As can be seen, as the need for neutron detection systems expands, and boron-coated straw detector systems replace ³He detectors in many applications, there will be an increasing need for a method of manufacturing greater number of boron-coated straws for these detectors, as well as straws with non-circular cross sections. Since the prior art process of manufacturing straws was limited by the limitations mentioned above, there exists a specific need for a better process that can produce quality boron-coating straws in increasing quantity.

### SUMMARY OF THE INVENTION

The present invention is an apparatus and a process for straw tube formation utilized in manufacturing the boron coated straw neutron detectors. A preferred embodiment of the process for creating a thin walled straw for use in a boron-coated straw neutron detector comprises providing a foil having a boron coating on a surface, forming the coated foil into a cylindrical tube having a longitudinal seam and the boron coated surface on the inside of the cylindrical tube, and then welding, preferably ultrasonically welding, the seam of the tube. Optionally, the cylindrical tube can then be drawn through a die to form a non-circular cross section, preferably a star-shaped cross section, straw tube.

Another embodiment comprises a continuous process beginning with providing a supply reel of coated foil ribbon. The foil ribbon is then folded into a cylindrical tube by continuously pulling the foil through a series of forming dies and over a circular cross-section mandrel. Preferably, the foil is pulled by a pair of spinning wheels. Preferably, the foil supply reel is also coupled to a tension motor to provide some resistance while the foil is pulled through the die. After the foil exits the forming dies, it has been formed into a cylindrical tube having a small overlap along the longitudinal seam of the tube. The seam is then welded, preferably ultrasonically welded, together as it exits the forming dies. Optionally, the welded cylindrical tube can then be drawn through another series of forming dies to form a non-circular cross section, preferably a star-shaped cross section, straw tube.

### BRIEF DESCRIPTION OF SEVERAL VIEWS OF THE DRAWINGS

A better understanding of the invention can be obtained when the detailed description set forth below is reviewed in conjunction with the accompanying drawings, in which:

FIG. 1 is a depiction of the prior art process for manufacturing boron-coated straw tubes developed by Dr. Lacy;

FIG. 2 is a process flow diagram depicting the process flow of a simplified embodiment of the present invention;

FIG. 3 is a photograph of a view through a microscope of an ultrasonically welded seam from an embodiment of a boron-coated straw tube made in accord with the process of the present invention;

FIG. 4 is a process flow diagram depicting the process flow for a continuous process embodiment of the present invention;

FIGS. 5A and B are frontal and side views of a series of forming disks as utilized in an embodiment of the present invention;

FIGS. 6 and 7 depict foil ribbon being formed into a cylindrical tube by being pulled through forming die as may be utilized in an embodiment of the invention;

FIG. 8 is an overhead view of an embodiment of the foil drive mechanism that pulls the cylindrical tube and preceding foil ribbon through the forming die;

FIG. 9 is a perspective view of the embodiment of FIG. 8.

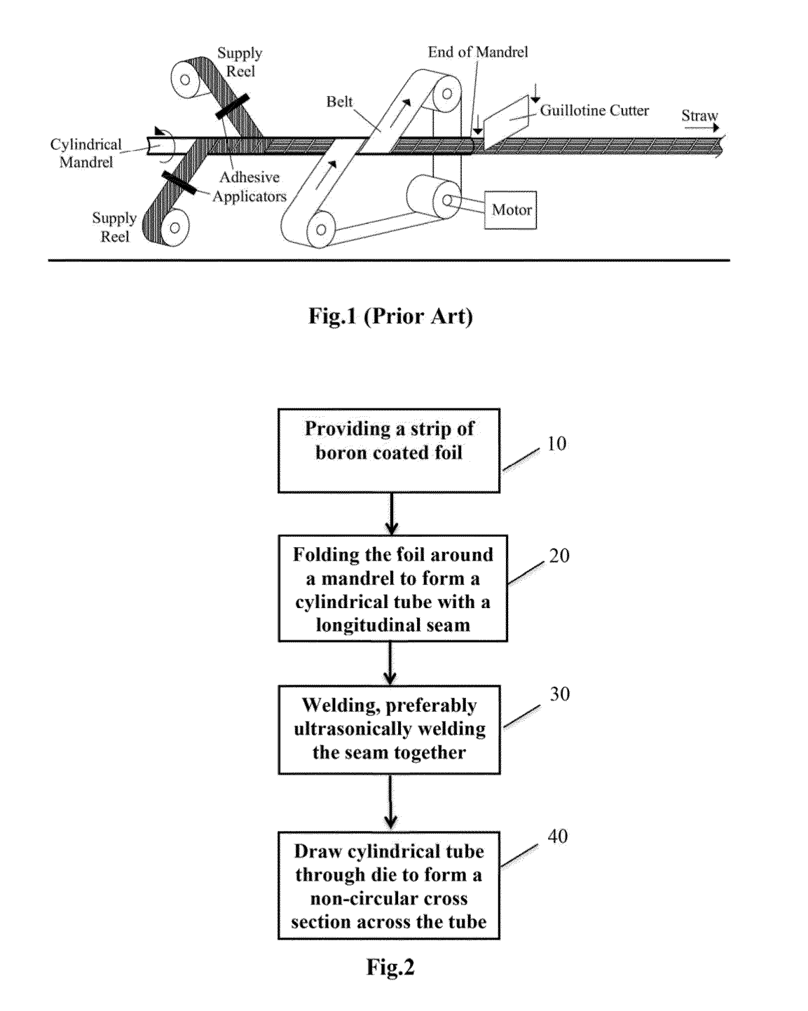

### DETAILED DESCRIPTION OF VARIOUS EMBODIMENTS OF THE INVENTION

The present invention is an apparatus and a process for straw tube formation utilized in manufacturing boron coated straw neutron detectors. As shown in FIG. 2, in one embodiment, primarily utilized in a low volume production environment, the process involves a first step 10 of providing a strip of foil having a boron coating. Preferably, the strip of foil has a width slightly wider than the desired straw tube circumference. Generally, the strip will be about 0.02-0.04 inches wider than the desired circumference. In order that the foil substrate produce minimal loss of incident neutron flux and to permit ease of forming, thin foil having thickness 0.0005″-0.002″ is preferably employed. Formability can be further enhanced by annealing the foil in a vacuum oven. Typically, copper foil is annealed at 300° C. for about 8 hours while aluminum, depending on grade, can be done typically at 200° C. for 8 about hours. As will be appreciated, the width and length of the foil strip can be determined by the desired straw tube dimensions. Generally, the diameter of the straw tube will be between about 2 mm and about 20 mm, and the length is between about 5 cm and about 300 cm. Preferably, the coated foil is manufactured using the process disclosed in U.S. patent application Ser. No. ______ filed ______, entitled “METHOD AND APPARATUS FOR COATING THIN FOIL WITH BORON CARBIDE” which claims priority to U.S. Provisional Application No. 61/717,000 (“the '000 application”) filed Oct. 22, 2012. Applicant hereby incorporates this application by reference in its entirety for all purposes, including but not limited to the description and characteristics of coated foils, the process for manufacturing coated foils, and the state of the art.

A next shaping step 20 involves rolling the coated foil around an elongated mandrel or rod having a circular cross-section. Preferably, the mandrel has a diameter smaller than the desired straw tube diameter. For example, for a 4 mm diameter straw tube, the mandrel should be about 3 mm in diameter. In this step, the foil can be manually rolled. Preferably, an apparatus is provided that includes the mandrel and a stop that holds the outer edge of the foil in place while rolling occurs. The foil and rod are rolled firmly, preferably against a solid flat surface such as a granite slab, forming the foil into a cylindrical tube to form a cylindrical tube with an overlapping longitudinal seam. The foil is formed keeping the boron coating on the inside of the cylindrical tube.

Once the cylindrical tube has been formed, the welding step 30 comprises welding the seam of the tube together, preferably utilizing ultrasonic welding. An ultrasonic welding machine suitable for use in the current process can be obtained for example from Sonobond Ultrasonic, Inc, Model MS-5010B. Such devices are commonly used in the foil industry for splicing long lengths of foil together in continuous production. For ultrasonic welding, a rod having the precise inner diameter of the intended straw tube is preferably inserted internal to rolled foil prior to welding to provide support while welding. This larger rod preferably expands the rolled tube to the precise diameter dimension of the desired straw. The use of the smaller forming rod in the previous step, causes the rolled tube to conform snuggly to the final weld rod. Preferably, an ultrasonic welding head rolls along the seam as the rod is translated at the circumferential velocity of the weld head. Generally, the welding head resembles a wheel or disc and it is rolled along the seam to perform the weld. The head vibrates perpendicularly to the seam and provides a high pressure at the seam. The layers of foil are essential rubbed together under high pressure to form a metallurgical bond without application of heat. For welding of thin foils, it is highly advantageous to utilize high ultrasonic excitation frequency of approximately 50,000 Hz.

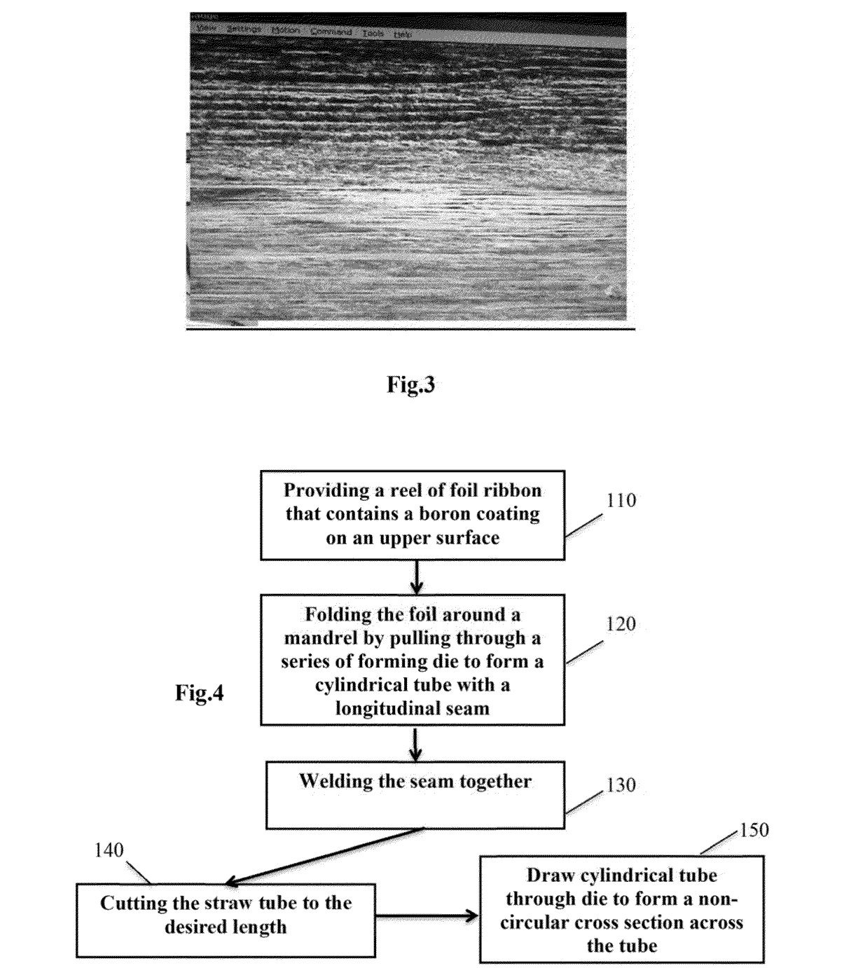

As can be seen in FIG. 3, ultrasonic welding of the coated foil seam produces welded seam that is difficult to distinguish from the remaining portion of the straw tube. FIG. 3 shows a view of a welded straw seam under a microscope at high magnification. It is particularly important that the weld seam is clean and smooth when the straws are to be further shaped in step 40.

After the cylindrical straw tube is formed, the tube may optionally be reshaped in step 40 to provide a non-circular cross section, preferably a star-shaped cross section. The cylindrical straw is drawn or pulled through a forming die having the desired non-circular shape. Preferably, the coated foil is manufactured using the process disclosed in U.S. patent application Ser. No. 13/683,404 filed Nov. 21, 2012, entitled “BORON-COATED STRAW DETECTORS WITH SHAPED STRAWS” which claims priority to U.S. Provisional Application No. 61/562,688 filed Nov. 22, 2011. Applicant hereby incorporates this application by reference in its entirety for all purposes, including but not limited to the description and characteristics of shaped straws, testing and evaluation of the straws, the process for manufacturing the shaped straws, and the state of the art.

Another embodiment is an apparatus and process for continuously forming straw tubes from foil ribbon with a boron coating. As shown in FIG. 4, this process begins in step 110 by providing a reel 112 of boron coated foil ribbon 114. The properties and characteristics are of the foil ribbon 114 are the same as described above except that the reel 112 contains a long ribbon of coated foil capable of supplying enough foil ribbon for multiple straw tubes.

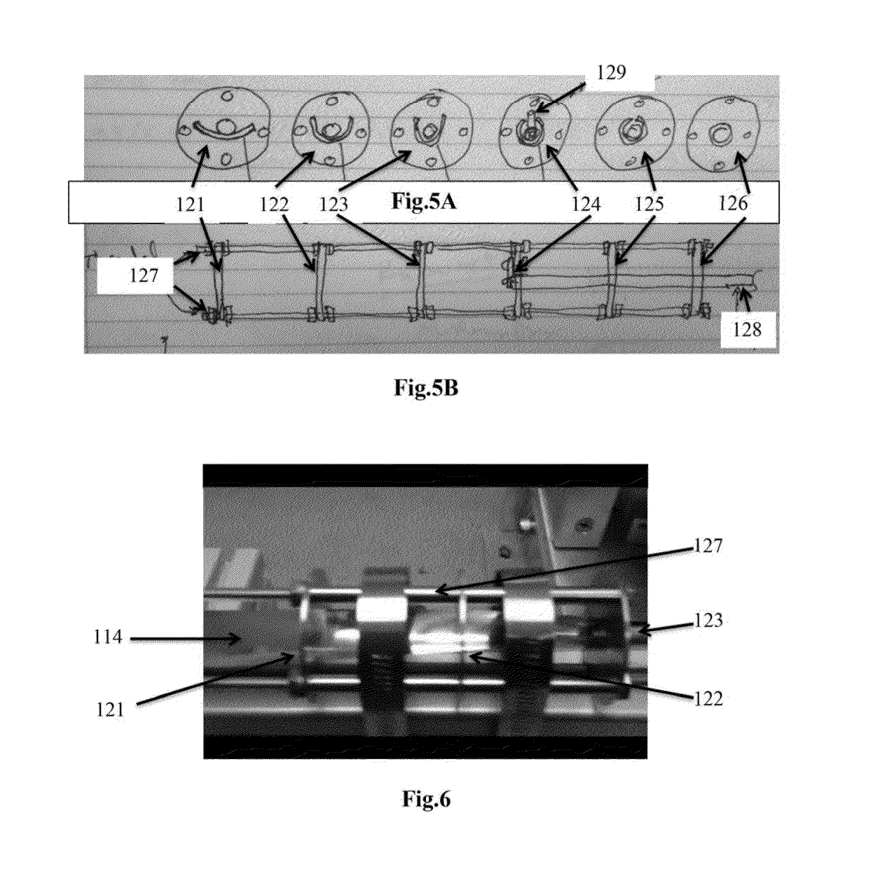

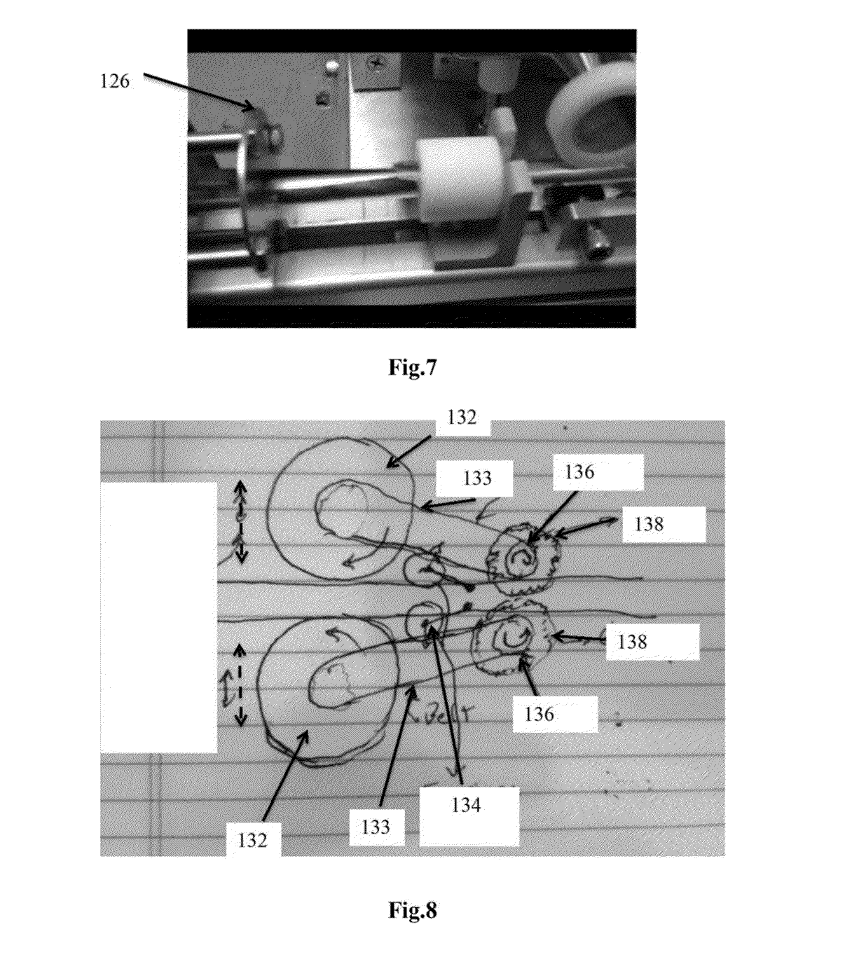

In the next step 120, the forward portion of the foil ribbon 114 is formed into a cylindrical tube. As shown in FIGS. 5A, 5B, 6 and 7, the foil ribbon is pulled through a series of forming dies 121-126 and over a circular cross-sectioned mandrel 128. As shown in FIG. 5A, preferably, the series of dies provide a gradual folding or rolling of the foil into a cylinder. The radius of the slot in each die may gradually decrease as the slot converges into a circular form. For example, the die 121 may have a 1.0 inch radius, die 122 may have a 0.8 inch radius, die 123 may have a 0.6 inch radius, and the remaining dies have a 0.4 inch radius as they close to a complete circle. As shown in FIG. 5B, the dies are preferably spaced apart to allow the foil ribbon to be coiled gradually as it is drawn through the dies. Preferably, as the foil is rolled into a cylinder, it is rolled around a circular cross-section mandrel 128 having a precise diameter that is slightly smaller than the desired straw inner diameter to allow for a very slight spring following welding. Dies 121-126 may be connected using threaded rods 127 to form a structure for the cylindrical formation. Mandrel 128 can be supported by a floating rod 129 suspended from a die 124. Although six die are shown in FIGS. 5A and 5B, as will be appreciated, fewer or more die can be utilized depending upon a number of factors, including but not limited to, the diameter of the straw tube being formed.

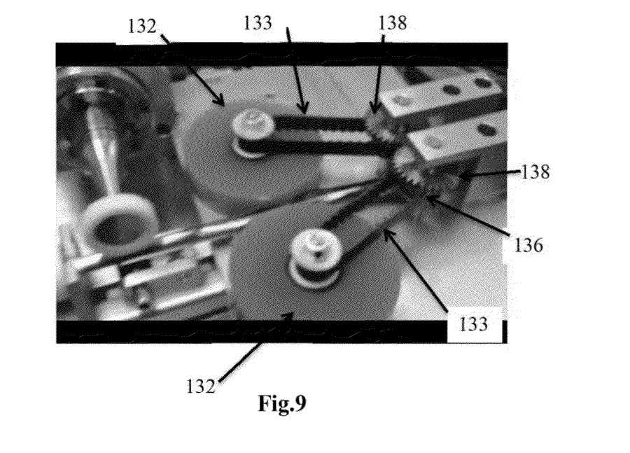

Preferably, the foil 114 is pulled continuously from the reel 112 through the dies 121-126 by a pair of spinning wheels 132. As shown in FIGS. 8 and 9, a preferred embodiment includes a pair of concave faced, rubberized wheels 132 located at the output of the device. In a preferred embodiment the wheels 132 are driven indirectly by belts 133 which are connected to pulleys 136 which are driven through gears 138, which are in turn driven by a motor (not shown). Preferably, the gap between wheels 132 is adjustable depending upon the diameter of the straw tube desired. During the folding step 120, the foil supply reel 112 is preferably coupled to a tension motor (not shown) to provide some resistance while it's being pulled into the die. After the foil ribbon 114 exits the forming dies 121-126 in step 120, a cylindrical tube with a circular cross section and a longitudinal seam has been formed. Preferably, an additional approximately 0.020″-0.040″ in foil width provides a small overlap on the seam of the tube.

The cylindrical tube is then drawn into welding step 130. In welding step 130, the cylindrical tube is preferably ultrasonic welded near the die output. The general characteristics of the ultrasonic welding process in this embodiment are the same as previously discussed. In a preferred embodiment, a single drive motor can turn the wheel gears 138 and drive the welder head.

Once a desired length of straw tube has been formed and ultrasonically welded, the straw tube is cut using a guillotine or shear cutter from the remaining in-process tube in step 140.

After formation of the cylindrical straw tube, and the tube exits the driving wheel mechanism, a shaping step 150 may be utilized. The cylindrical tube is preferably driven through another series of forming dies which form the straw into a non-cylindrical shape, preferably star-shaped cross-section. As used herein, “star-shaped” includes a star having any number of points. In a preferred embodiment, the cylindrical tube is pulled through a star-shaped mold that forces tube to take that star shape. The general configuration and characteristics of the non-circular shapes as discussed above are equally applicable in this step. Step 150 may occur either prior to or after step 140.

In alternative embodiments to the processes described above, those skilled in the art will recognize that other forms of joining and producing a clean seam in the straw may be applicable. Examples of alternative techniques include laser welding using ND:YAG pulsed laser, such as the iWeld 980 supplied by LaserStar Technologies Corporation, One Industrial Court, Riverside, R.I. 02915. Other alternatives include solder or braze joining. Since the cylindrical straw tubes or the non-circular cross section straw tubes are preferably contained within a hermetic housing, there is no absolute requirement the joint be hermetically sealed. In some applications simple tack soldering at widely spaced points can produce highly functional larger cylindrical tubes.

As can now be appreciated, there are several advantages of the present invention over the prior art. These advantages include following:

| | Contractor straw | Welded straw |
|---|---|---|
| Materials | Contains adhesive that | All metal construction, |
| | outgasses | with no adhesives to |
| | | outgas |
| Operation | High-temperature operation | Operation at high |
| | limited by adhesive | temperatures, up to |
| | outgassing | 170° C. |
| Forming | Thick laminated structure | Can be easily formed to |
| | cannot be formed into other | take desired shape (star- |
| | shapes | like corrugation) |
| Supply | Requires exporting of coated | - none - |
| chain issues | foil & importing of straw | |
| | material | |
| Production rate | ?? | 60 meters/hour |
| Production cost | ?? | $100/hour |

Although the invention has been described in reference to its preferred embodiments, those of skill in the art may appreciate from this description various changes and modifications which can be made thereto which do not depart from the spirit and scope of the invention as described and claimed herein.

1. A process for creating a thin walled straw tube for use in a boron-coated straw neutron detector comprising:
providing foil having a boron coating on a surface;
forming the coated foil into a cylindrical tube having a longitudinal seam an interior boron coated surface; and
ultrasonically welding together the edges of the seam of the tube.

2. The process of claim 1, further comprising the step of advancing the cylindrical tube through a forming dye to form a non-circular shaped tube.

3. The process of claim 2 wherein the non-circular shape is a star-shape.

4. The process of claim 1 wherein said providing foil step comprises providing a roll of coated foil on a reel.

5. The process of claim 1 wherein said step of forming a cylindrical tube comprises folding the foil around a mandrel.

6. The process of claim 5 wherein said mandrel comprises a rod slightly smaller in diameter than the diameter of the tube being formed in order to compensate for spring following welding.

7. The process of claim 1, wherein said foil has a width slightly wider than a desired tube circumference.

8. The process of claim 1 wherein said step of forming a cylindrical tube comprises drawing the foil through a series of forming dyes and over a circular mandrel.

9. The process of claim 8 wherein the drawing of said foil utilizes a pair of concave faced, rubberized wheels.

10. The process of claim 8 wherein the series of forming dye comprises three or more dye.

11. The process of claim 8 further comprising the step of providing some resistance to the foil producing tension as it is pulled through the dyes.

12. The process of claim 1 further comprising removing the cylindrical tube from the mandrel and inserted a rod having an outside diameter approximately equal in diameter to the desired inside diameter of the cylindrical tube that is being formed.

13. A process for creating a thin walled straw tube for use in a boron-coated straw neutron detector comprising:
providing foil having a boron coating on a surface;
forming the coated foil into a cylindrical tube having a longitudinal seam and an interior boron coated surface by folding the foil around first rod slightly smaller in diameter than the diameter of the tube being formed in order to compensate for spring following welding;
removing the cylindrical tube from the first rod and inserting a second rod having an outside diameter approximately equal in diameter to the desired inside diameter of the cylindrical tube that is being formed; and
welding together the edges of the seam of the tube.

14. A process for creating a thin walled straw tube for use in a boron-coated straw neutron detector comprising:
providing a reel of foil ribbon having a boron coating on a surface;
pulling the coated foil ribbon through a series of forming dye and over a cylindrical mandrel to form a cylindrical tube having a longitudinal seam an interior boron coated surface;
welding together the edges of the seam of the tube;
cutting the straw tube to the desired length after welding.

15. The process of claim 14, wherein said welding step comprises ultrasonically welding together the edges of the seam of the tube.

16. The process of claim 14, further comprising the step of advancing the cylindrical tube through a forming dye to form a non-circular shaped tube.

17. The process of claim 16 wherein the non-circular shape is a star-shape.

18. An apparatus for manufacturing straw tubes from foil ribbon comprising:
a reel comprising a foil ribbon;
a series of forming dye through which the foil ribbon is to be pulled, each dye comprising a slot for gradually folding the foil ribbon into a cylindrical straw.
a wheel drive mechanism for pulling the foil through the dye, the wheel drive mechanism comprising a pair of rotatable wheels, a pair of bands, a pair of pulleys, each bands operably connected to one wheel and one pulley, wherein rotation of the pulleys rotates the wheels; and
ultrasonic welding machine for welding together the edges of the cylindrical tube after formation.

19. The apparatus of claim 18 wherein said rotatable wheels comprise a pair of concave faced, rubberized wheels.

20. The apparatus of claim 18 wherein the series of forming dye comprises three or more dye.

21. The process of claim 18, further comprising a tension regulator for providing resistance to the foil and producing tension as it is pulled through the dyes.

22. In a radiation detector comprising boron-coated straw tubes, the improvement comprising boron coated straw tubes being formed from rolled foil and having a longitudinal seam welded closed through ultrasonic welding.
